(19) United States
(12) Patent Application Publication
(10) Pub. No.: US 2023/0010545 A1
(43) Pub. Date: Jan. 12, 2023

(54) AIDC DEVICE CRADLE

(71) Applicant: Charles Cagliostro, Bronxville, ME (US)

(72) Inventor: Charles Cagliostro, Bronxville, ME (US)

(21) Appl. No.: 17/674,115

(22) Filed: Feb. 17, 2022

Related U.S. Application Data
(60) Provisional application No. 63/220,372, filed on Jul. 9, 2021.

(51) Int. Cl. H02J 7/00

(52) U.S. Cl. CPC H02J 7/0044

(57) ABSTRACT

An AIDC device cradle includes a stand having a post, base plate, and a protruding head. An expandable tray rotatably attached to the axle head via a pivot pin. The expandable tray including an upper bracket and a lower bracket configured to expand and contract along a longitudinal axis of the expandable tray such that the size of the expandable tray may vary to accommodate AIDC device case with an AIDC device or an AIDC device directly. The upper bracket and the lower bracket having side walls which are perpendicular to the longitudinal axis of the expandable tray helping to secure the AIDC device within the tray. A plurality of locking holes and slots are provided to lock the cradle in position and secure the AIDC device within the device cradle. Integrated charging options are provided.

### CROSS-REFERENCE TO RELATED APPLICATIONS

The present application claims priority to U.S. Provisional Patent Application Ser. No. 63/220,372, filed on Jul. 9, 2021 entitled “AIDC Device Cradle”, the disclosure of which is hereby incorporated in its entirety at least by reference.

### BACKGROUND OF THE INVENTION

### 1. Field of the Invention

The present invention generally relates to AIDC devices, more specifically it relates to a locking adjustable cradle with onboard charger for AIDC devices.

### 2. Description of Related Art

AIDC (Automatic identification and data capture) is a term used to group together several different device technologies that are used to automatically identify items, collect data, and enter this data into computer systems. Most of the data that is captured by such devices is attached to barcodes, RFID-equipped access cards, or Smart Cards which can be enhanced further with the use of Biometric data. There have been advancements in AIDC over the years and it is now possible for users around the world to interact with millions of business processes and systems using AIDC devices. Object tracking using Electronic Article Surveillance (EAS) systems which also uses RFID Tags prevents theft of the items from stores. Locating objects through the uses of Real Time Locating Systems (RTLS) to name just a couple of the many opportunities which AIDC based technology has to offer. As such devices began to appear in most retail environments, merchants began looking at ways to make them more stable, secure and more presentable to their operators. Consequently, a solution is need.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present invention to provide an AIDC cradle that can receive an AIDC device that is configured to be adjusted to various angles to facilitate the operation and use while charging and preventing theft of the AIDC device. It is another object of the present invention to provide an AIDC cradle that is configured to securely mount to a flat surface.

In order to do so, an AIDC device cradle is provided, comprising a stand post having a top portion and a bottom portion, the bottom portion attached to a base plate and the top portion attached to a protruding head; an expandable tray rotatably attached to the protruding head via a pivot pin, wherein the expandable tray comprises an upper bracket and a lower bracket configured to expand and contract along a longitudinal axis of the tray such that the size of the expandable tray may vary, each the upper bracket and the lower bracket including side walls, wherein the side walls are perpendicular to the longitudinal axis of the expandable tray; the expandable tray configured to receive an AIDC device or an AIDC device case, wherein the expandable tray is configured to be lockable in a selected position and the expandable try includes a plurality of openings enabling a user to lock the AIDC device or an AIDC device case within the expandable tray.

In one embodiment, the lower bracket comprises an integrated charger connection configured to charge the AIDC device when the AIDC device is positioned in the expandable tray. In one embodiment, the expandable tray comprises a wireless charging component. In one embodiment, the base plate includes holes configured to receive fasteners such that the base plate may be fixed to a surface. In another embodiment, the AIDC device cradle is constructed from a rigid material.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a right exploded perspective view of an AIDC device cradle according to an embodiment of the present invention.

FIG. 2 is a left perspective view of the AIDC device cradle according to an embodiment of the present invention.

FIG. 3 is a bottom perspective view of the AIDC device cradle with a detailed view showing the charger according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide an AIDC device cradle.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

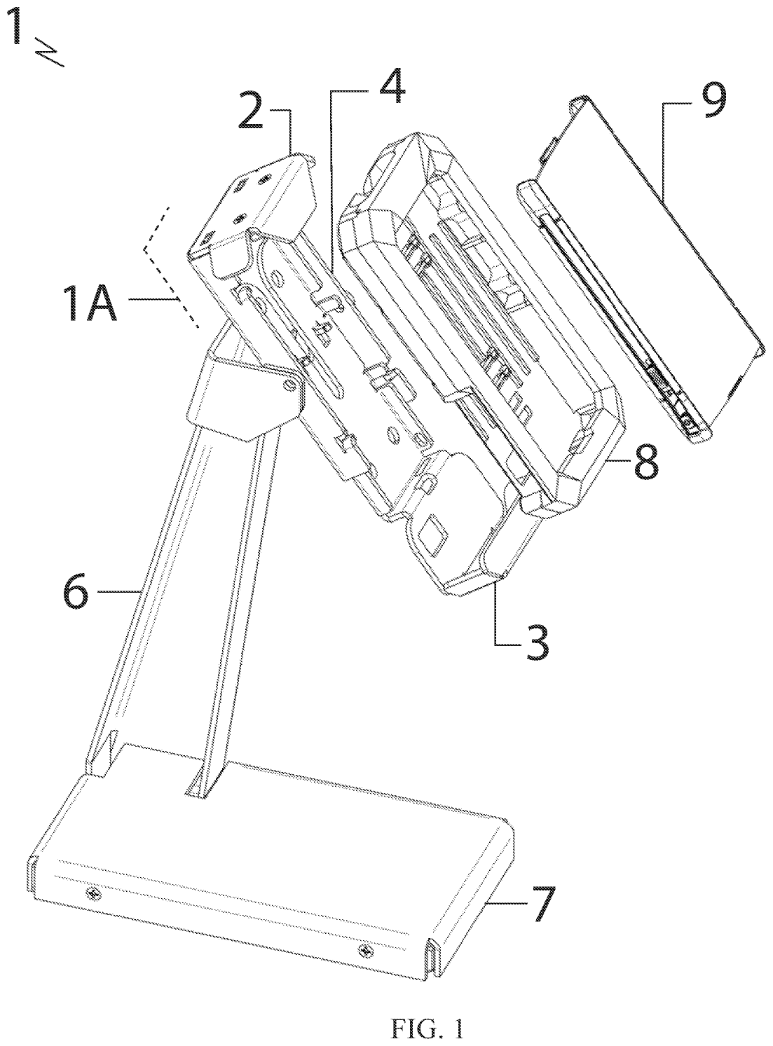

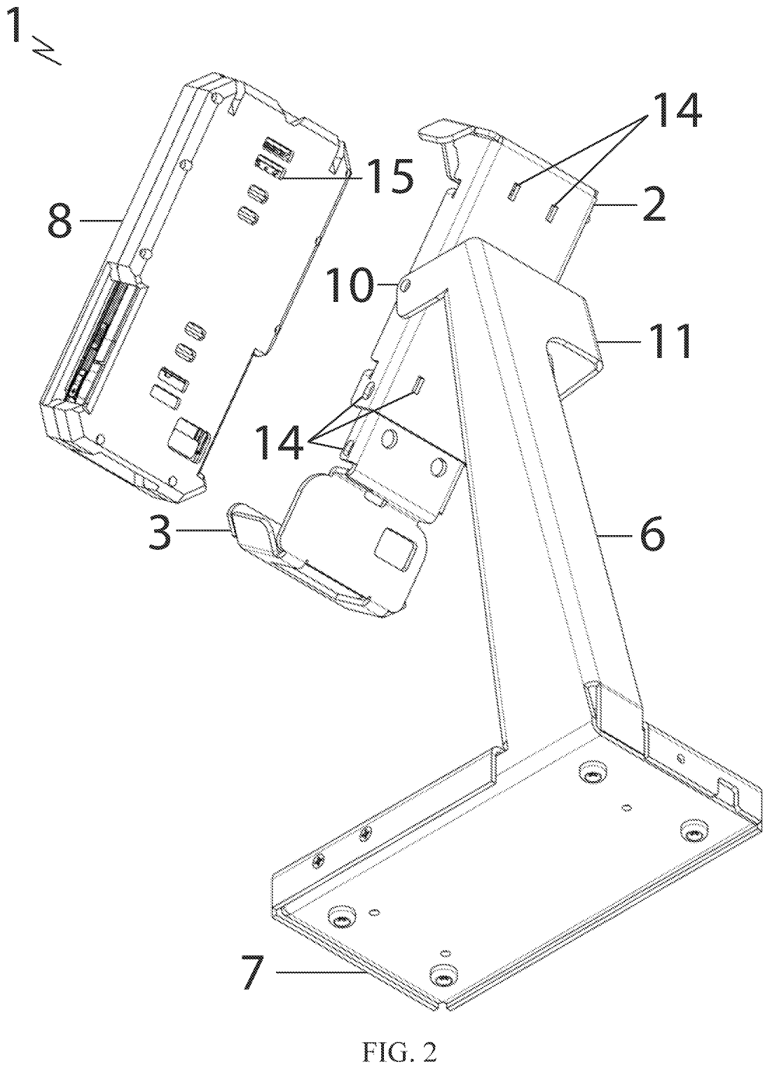

Referring now to any of the accompanying FIGS. 1-3, an AIDC device cradle 1 is illustrated. In one embodiment, the AIDC device cradle 1 comprises a tray 1A configured to receive an AIDC device 9. In one embodiment, the tray 1A is rectangular and sized and shaped to receive a rectangular AIDC device. In some embodiments, the tray 1A is configured to receive an AIDC case 8, wherein the AIDC case 8 is configured to receive the AIDC device 9. Likewise, the AIDC case 8 is rectangular and configured to receive a rectangular AIDC device 9 as illustrated in the accompanying FIGS. 1-3. Although, the popular AIDC devices and corresponding AIDC cases are rectangular, it should be understood that the shape may vary in alternative embodiments such that other shaped AIDC devices may be accommodated.

Advantageously, in one embodiment, the tray 1A is expandable such that multiple sized AIDC cases and AIDC devices may be received by the tray 1A. In one embodiment, the expandable tray 1A comprises an upper bracket 2 and a lower bracket 3 each configured to contract and expand towards and away from each other respectively. Both the upper bracket 2 and the lower bracket 3 have the freedom of motion to independently move in relation to each other such that one bracket may be fixed while the other is adjusted. In some embodiments, the upper bracket 2 and the lower bracket 3 includes side walls 4 and 5 respectively, wherein the side walls are perpendicular to the longitudinal axis of the tray 1A. The side walls 4 and 5 help secure the AIDC device and/or AIDC case from lateral movement within the tray 1A. In one embodiment, the side walls and/or brackets include openings/slots 14 configured to receive a plurality of fastener options or locks, wherein the fasteners enable the AIDC device cradle to lock in the AIDC device and/or AIDC case within the tray 1A. In one embodiment, the fasteners are screws, but other securement methods or elements may be used as well known in the art, including but not limited to laptop security locks, padlocks or other quick locking devices. In some embodiments, slots 15 are also provided on the AIDC case such that a hand strap can be secured to the AIDC case.

In one embodiment, the AIDC device cradle 1 further comprises a stand comprised of post 6 attached to a base plate 7, wherein the stand includes a protruding head 11 on the top portion of the post 6. In one embodiment, the tray 1A is rotatably connected to the protruding head 11 via pivot pin 10, which enables the tray 1A and attached AIDC device to rotate about the head 11 to any desirable angle. In some embodiments, the base plate includes holes 16 enabling fasteners to secure for the base plate to a surface.

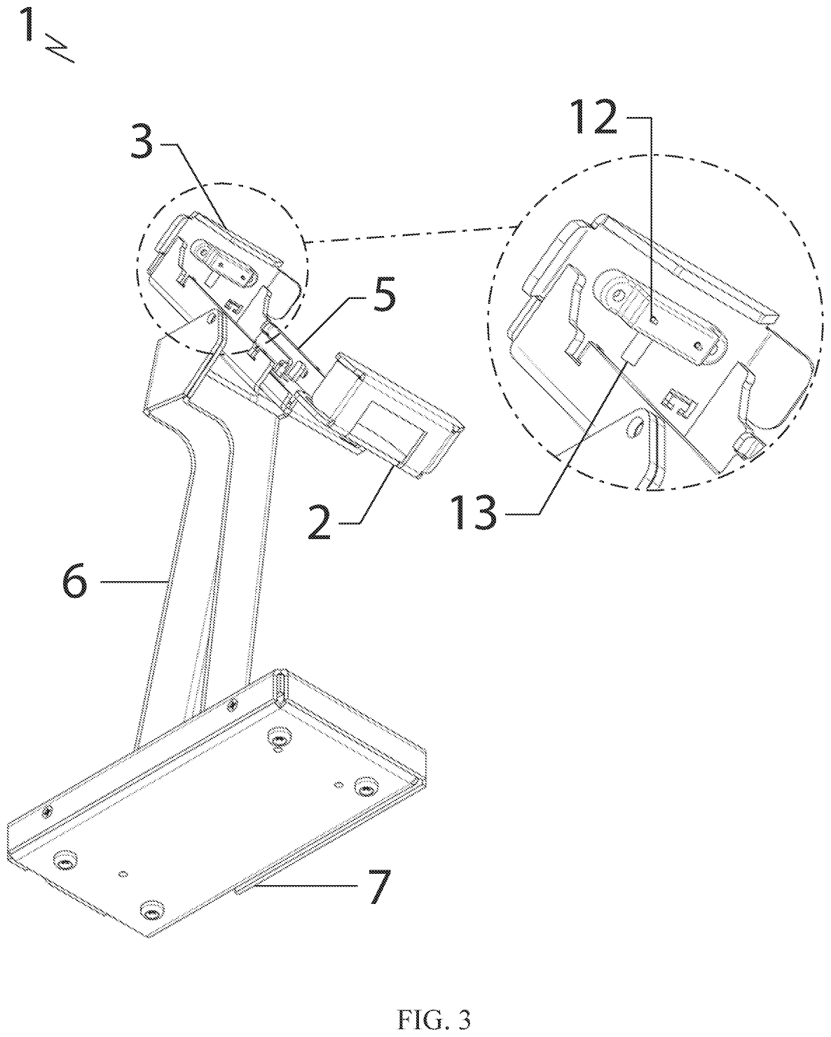

Best seen in FIG. 3, a charger connection 12 is integrated on the upper bracket 3 of the AIDC cradle device 1, wherein the charger connection 12 provides power to the AIDC device via power cord 13 when the AIDC device is situated in the tray 1A. In other embodiments, the AIDC device is configured to change wirelessly via an integrated wireless charging component on the AIDC cradle. In some embodiments, other ports or connections may be provided for charging, data transfer, etc. such as USB, serial, parallel ports, or similar.

It should be understood that the materials may vary, however, in one embodiment the AIDC cradle device 1 including the tray 1A, brackets, stand, and base are constructed from a rigid material, such as metal or plastic. In one embodiment, the AIDC case 8 is made from a rigid yet flexible material, including but not limited to rubber, silicone, PVC, ABS plastic, or similar.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An AIDC device cradle comprising:
a stand post having a top portion and a bottom portion, the bottom portion attached to a base plate and the top portion forming a protruding head;
an expandable tray rotatably attached to the protruding head via a pivot pin, wherein the expandable tray comprises an upper bracket and a lower bracket configured to expand and contract along a longitudinal axis of the tray such that the size of the expandable tray may vary, each the upper bracket and the lower bracket including side walls, wherein the side walls are perpendicular to the longitudinal axis of the expandable tray;
the expandable tray configured to receive an AIDC device or an AIDC device case, wherein the expandable tray is configured to be lockable in a selected position and the expandable try includes a plurality of openings enabling a user to lock the AIDC device or an AIDC device case within the expandable tray.

2. The AIDC device cradle of claim 1, wherein the lower bracket comprises an integrated charger connection configured to charge the AIDC device when the AIDC device is positioned in the expandable tray.

3. The AIDC device cradle of claim 1, wherein the expandable tray comprises a wireless charging component.

4. The AIDC device cradle of claim 1, wherein the base plate includes holes configured to receive fasteners such that the base plate may be fixed to a surface.

5. The AIDC device cradle of claim 1, wherein the AIDC device cradle is constructed from a rigid material.
